(19) United States
(12) Patent Application Publication
(10) Pub. No.: US 2014/0063214 A1
(43) Pub. Date: Mar. 6, 2014

(54) IMAGING DEVICE WITH A WIDE VIEWING ANGLE

(71) Applicant: Commissariat a l'Energie Atomique et Aux Energies Alternatives, Paris (FR)

(72) Inventor: Serge GIDON, La Murette (FR)

(73) Assignee: Commissariat a I'Energie Atomique et Aux Energies Alternatives, Paris (FR)

(21) Appl. No.: 13/975,835

(22) Filed: Aug. 26, 2013

(30) Foreign Application Priority Data
Aug. 28, 2012 (FR) 1258033

(51) Int. Cl. H04N 5/222; H04N 5/33

(52) U.S. Cl. CPC H04N 5/222; H04N 5/33
USPC 348/61; 348/335; 348/164

(57) ABSTRACT

An imaging device including an element having at least a reflective sphere portion wall, a converging lens, and an image detection array, wherein the lens and the array are fixedly assembled with respect to each other on a mount, said mount being hinged with respect to said element.

### BACKGROUND

The present disclosure relates to an imaging device with a wide viewing angle, and more specifically to such an imaging device intended to detect the presence of individuals in an observed scene.

### DISCUSSION OF THE RELATED ART

The detection of the presence of people in a scene, for example, a room or an outdoor site, is here considered. It is mainly desired to identify the fact that one or several persons are present, to roughly locate the people in the scene, or even to detect people's motions. Such a detection may be intended, in home automation systems, to regulate a heating or an air-conditioning system according to the number of people present. It may also be used to start a specific device, for example, a shop window lighting or the starting of an audio or video device, when one or several persons come close to it.

To achieve this, it is generally provided to arrange an imaging device having a wide viewing angle, for example, on the ceiling of a room, or in an angle of any type of enclosure, to generally scan the scene to be monitored and to enable to form the image of this enclosure on a sensor. In the specific case of the detection of the number and of the position of people, it will be preferred to record on the sensor a thermal image of the scene by using a system operating in infrared, for example, at infrared wavelengths close to 10 μm. For motion detection, rays in the visible range may be used.

Several problems arise to form such an imaging device of wide viewing angle. Known wide-angle devices used in photography generally are extremely expensive optical devices, implying a high number of lenses and/or of mirrors requiring a high-precision adjustment of their characteristics and relative positions. Indeed, in photography, wide angle devices providing a sharp image, of the best possible quality, are desired to be formed.

Presence and motion detection devices having a wide viewing angle, and being both inexpensive and simple to form and to install, are thus needed.

### SUMMARY

An embodiment provides an imaging device comprising an element having at least a reflective wall in the shape of a sphere portion, a converging lens, and an image detection array, wherein the lens and the array are fixedly assembled with respect to each other on a mount, the mount being hinged with respect to the element.

According to an embodiment, the mount is assembled in ball joint, prismatic joint, or cylindrical joint connection with the element.

According to an embodiment, the joint between the mount and the element is formed at the wall surface.

According to an embodiment, the array and the lens are arranged with respect to the element so that a beam which would be transmitted by the lens from the array to the element reaches a portion only of the wall and is reflected towards an area with an angular span greater than 90°.

According to an embodiment, the device further comprises a diaphragm placed between the element and the converging lens.

According to an embodiment, the element is a ball.

According to an embodiment, the element is a ball bearing ball.

According to an embodiment, the ball has a radius ranging between 7 and 15 mm.

According to an embodiment, the lens has a diameter approximately ranging from 5 to 20 nm and a focal distance of the same order of magnitude.

According to an embodiment, the image detection array is capable of detecting infrared rays, the device being capable of detecting the presence of people placed several meters away from the element.

According to an embodiment, the image detection array is capable of detecting rays in the visible range, the device being capable of detecting the motion of objects placed several meters away from the element.

According to an embodiment, the mount comprises several arms enclosing the element and assembled in ball joint connection with the element.

According to an embodiment, the lens is a Fresnel lens.

An embodiment further provides a use of the above imaging device to detect people and/or to detect motions in a scene.

The foregoing and other features and advantages will be discussed in detail in the following non-limiting description of specific embodiments in connection with the accompanying drawings.

### BRIEF DESCRIPTION OF THE DRAWINGS

FIG. 1 very schematically shows a wide angle optical imaging device;

FIG. 2 very schematically shows an alternative embodiment of a wide angle optical imaging device; and

FIG. 3 shows a specific embodiment of the mechanical assembly of the device of FIGS. 1 and 2.

### DETAILED DESCRIPTION

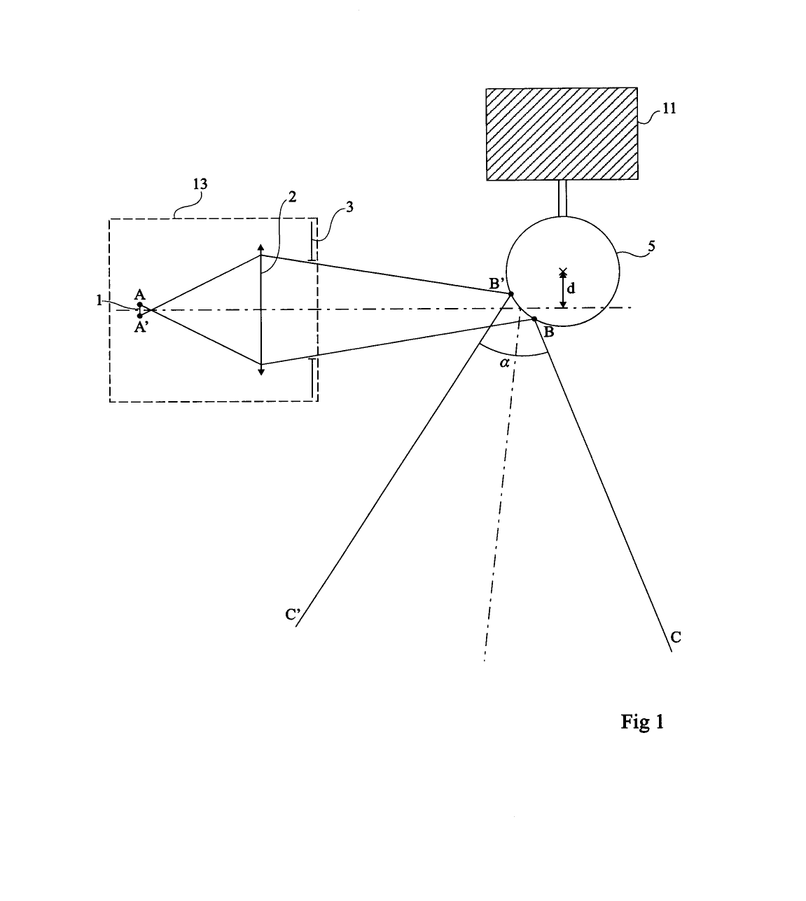

FIG. 1 shows the optical diagram of a wide angle imaging device. This device comprises a sensor 1 formed of an array image detection device comprising an array of light-sensitive pixels, possibly of bolometric type, that is, sensitive to the heating caused by light and more specifically by an infrared radiation. In the case of motion detection, array detection device 1 may be sensitive to rays in the visible range. The imaging device also comprises a converging lens 2, a diaphragm 3, and a reflective ball 5. Lens 2 forms a device of wide numerical aperture, for example, on the order of one, in the case where its focal distance is equal to its diameter. Diaphragm 3 is positioned between lens 2 and ball 5 to set limits for the light beams (to filter parasitic rays and limit aberrations). Sensor 1 is arranged slightly behinds the focus of lens 2, the ball being used as a diverging lens (strong diverging power). In the illustrated example, the optical axis of the lens cuts the ball towards the bottom thereof and is spaced apart by a distance d from the ball center.

Designating with A and A′ two opposite ends of the sensor, the most diverging rays are the rays going from point A to the opposite end of lens 2 and from point A′ to the opposite end of this lens. These rays delimit a beam which hits between points B′ and B reflective ball 5, from which they are reflected in directions corresponding to rays designated with references C′ and C towards a scene to be observed. Angular aperture a of the beam delimited by rays C and C′ may be wide, for example, greater than 90°, if the focal length of lens 2, the position of sensor 1, and the distance between the lens and the sensor are properly selected.

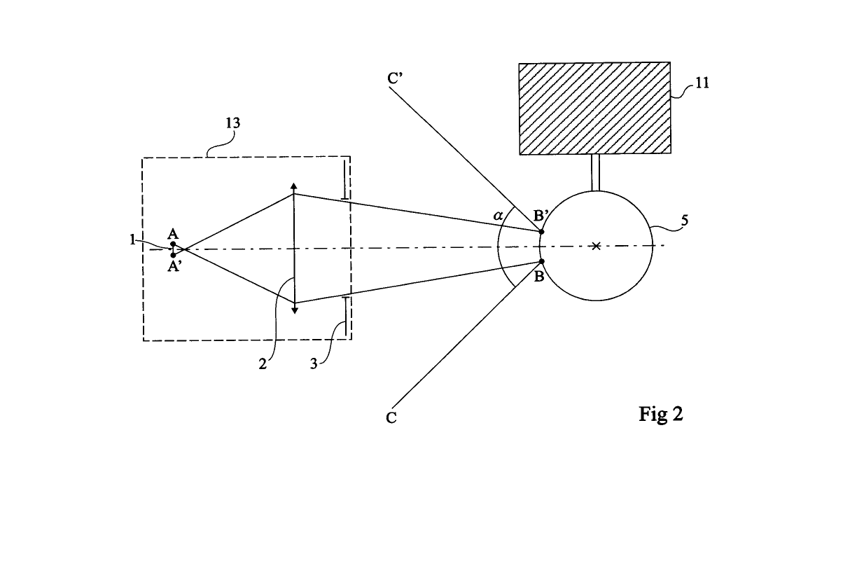

FIG. 2 illustrates an alternative embodiment of the wide angle optical imaging device of FIG. 1.

This drawing illustrates a sensor 1 formed of an array image detection device comprising an array of light-sensitive pixels. Array detection device 1 may be provided to be sensitive to rays in the visible range or in infrared, according to the desired application. The imaging device also comprises a converging lens 2, a diaphragm 3, and a reflective ball 5. Diaphragm 3 is positioned between lens 2 and ball 5 to set limits for the light beams. Sensor 1 is arranged slightly behind the focus of lens 2, the ball behaving as a diverging lens. In the illustrated example, the optical axis of lens 2 cuts the ball at its center.

Designating with A and A′ two opposite ends of the sensor, the most diverging rays are the rays going from point A to the opposite end of lens 2 and from point A′ to the opposite end of this lens. These rays delimit a beam which hits between points B′ and B reflective ball 5, from which they are reflected in directions corresponding to rays designated with references C′ and C towards a scene to be observed. Angular aperture a of the beam delimited by rays C and C′ may be wide, for example, greater than 90°, if the focal length of lens 2, the position of sensor 1, and the distance between the lens and the sensor are properly selected. In this example, the observed scene is behind detection system 10.

No specific rule will here be given to set the values of the focal length of lens 2, of the position of sensor 1, of the distance between the lens and the sensor, and of the position of diaphragm 3, given that, in practice, to optimize such a system, optical calculation software such as the software sold under trade name ZEMAX is currently used. The previously-described general parameters (sensor size, focal length of lens 2, numerical aperture of the system, and diameter of ball 5) are introduced as input parameters of the software and these parameters are optimized to obtain a desired result, under the constraint of a desired field of observation a. In practice, these dimensions may be selected so that angle a is greater than 90°.

As shown, ball 5 is for example rigidly attached to a support 11 intended to be fastened to the ceiling or to a wall of an enclosure to be monitored. The assembly of lens and sensor 1 is connected to a mount 13 so that the distance between the lens and the sensor is maintained fixed. Further, as will be described in detail hereafter as an example in relation with FIG. 2, mount 13 is preferably jointed to ball 5 to enable to vary the direction, and possibly the aperture, of observation beam C′-C.

As an embodiment, a ball of the type used in ball bearings may be selected as ball 5. Indeed, the standards imposed for the forming of ball bearing balls give them a substantially spherical shape with an extremely low roughness, which is in particular much lower than the considered optical wavelength, more specifically in the case where the optical wave to be detected has a wavelength on the order of 10 μm.

Lens 2 may be a simple lens, for example, of Fresnel lens type, formed by molding of a plastic material.

Array sensor 1 will not be described in detail since many embodiments of such sensors are well known in the art.

It should be noted that the wide angle imaging device described hereafter introduces a certain optical distortion and especially obstruction vignetting phenomena (due to the possible presence of the sensor in the field). Thus, the sensor will preferably be previously calibrated to enable to correct the position of targets (individuals) present in the observed scene.

As an example, and without this being a limitation, ball 5 may have a radius ranging from 7 to 15 mm, for example, 10 mm, the lens may have a diameter approximately ranging from 5 to 20 mm, for example, 10 mm, and a focal distance of the same order of magnitude as its diameter. The distance between the lens and the ball may range between 30 mm and 60 mm. As a result of such dimensions, the total bulk of the previously-described device will be such that this device, including its mount, can be contained within a parallelepiped having a long side length shorter than 10 cm and a short side length shorter than 5 cm. Generally, the scene to be observed will be located a few meters away from the imaging device.

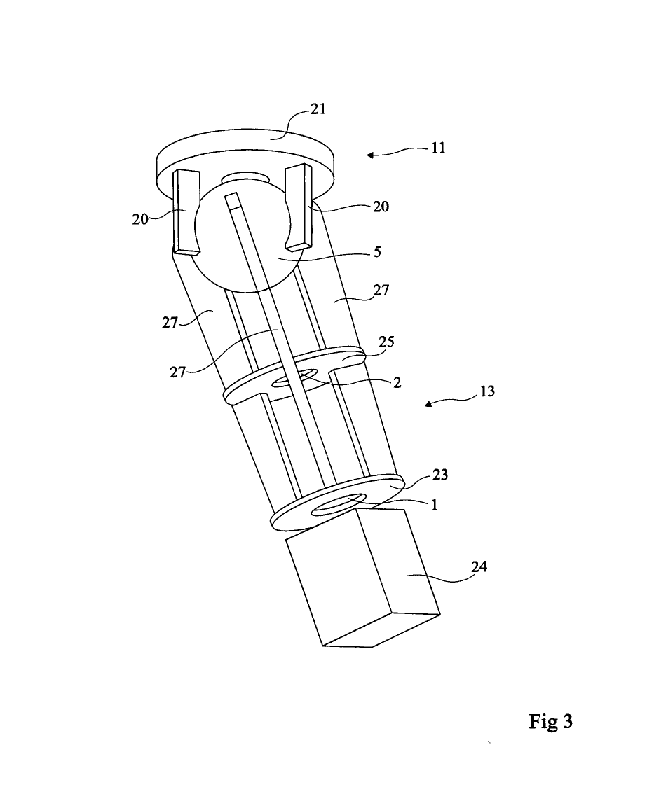

FIG. 3 shows an example of mechanical assembly of the previously-described device, where ball 5 is used both for its optical properties and for its mechanical properties. It thus forms both a reflector and a ball joint element.

Support 11 of ball 5 is for example formed of three arms, 120° away from one another, thus clamping the ball. The arms are rigidly attached to a base 21. Once ball 20 has been clamped between the arms, it may be fastened thereto, for example, by spots of glue. It may also be provided to maintain a motion between the arms and the ball, with friction.

Mount 13 of the lens-sensor assembly comprises a first ring-shaped support 23 intended to receive sensor 1, the sensor being associated with detection electronics 24. A second ring 25 is intended to receive lens 2, or even diaphragm 3. Rings 23 and 25 are connected together by a mount which ends in three arms 27, 120° away from one another, which clamp the ball together. Thus, the relative position of the sensor and of the lens is set by the position of rings 23 and 25, and mount 13 may be rotated with respect to ball 5, which is then used as a jointing element (for the ball joint), to aim at a selected portion of a scene. A blocking element, not shown, may also be provided. As a variation, the friction hold of the ball in mount 13 may be sufficient. The device is thus very simple to install and to adjust.

As shown in FIG. 1, the optical axis of sensor 1 may be off-centered from the center of ball 5. To achieve this, it may be provided to place sensor 1 and lens 2 in off-centered position with respect to the central axis of mount 13.

Various alternative embodiments will occur to those skilled in the art. In particular, one or several displays may be provided, in addition to diaphragm 3, to avoid for parasitic light to reach the detector. Mount 13 may also be replaced with any system with one arm attached to ball 5.

According to another alternative embodiment, other types of jointing, and thus of motion, between mount 13 and the ball, may be provided. Especially, various mechanical structures may be used so that the two elements are mobile according to a motion of prismatic joint type (the distance separating ball 5 from mount 13 being variable) or of cylindrical joint type, especially if the field of view of the imaging device is desired to be modified.

A device such as described hereabove may be used for many applications. Especially, if image detection device 1 is sensitive to infrared rays, it may be used to detect the position of people in a room, or also to detect people's motions. If image detection device 1 is sensitive to rays in the visible range, it may be used to detect people's motions in a room (by detection of motions of blurred forms in the monitored scene).

It should further be noted that, although all along this description, a device comprising a reflective spherical ball has been mentioned, it should be understood that this ball may be replaced, with no modification of the device operation, with an element comprising at least one reflective wall having the shape of a sphere portion. Of course, in this case, the reflective wall will be properly positioned to direct the image of the scene to be observed towards the lens, and the connection between mount 13 and the element will be adapted to the shape of this element. Thus, a half-ball or other structures having spherical portions may be provided to replace ball 5 provided herein.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An imaging device comprising at least a reflective spherical ball portion, a converging lens, and an image detection array, wherein the lens and the array are fixedly assembled with respect to each other on a mount, said mount being hinged on the ball (5) by a ball joint.

2. The device of claim 1, wherein the array and the lens are arranged with respect to the ball so that a beam which would be transmitted by the lens from the array to the ball reaches a portion only of said wall and is reflected towards an area with an angular span (a) greater than 90°.

3. The device of claim 1, further comprising a diaphragm placed between the ball and the converging lens.

4. The device of claim 1, wherein the ball is a ball bearing ball.

5. The device of claim 1, wherein the ball has a radius ranging between 7 and 15 mm.

6. The device of claim 1, wherein the lens has a diameter approximately ranging from 5 to 20 mm and a focal distance of the same order of magnitude.

7. The device of claim 1, wherein the image detection array is capable of detecting infrared rays, the device being capable of detecting the presence of people placed several meters away from the ball.

8. The device of claim 1, wherein the image detection array is capable of detecting rays in the visible range, the device being capable of detecting motions of objects placed several meters away from the ball.

9. The device of claim 1, wherein the mount comprises several arms enclosing the ball and assembled in ball joint connection with the element.

10. The device of claim 1, wherein the lens is a Fresnel lens.

11. A use of the imaging device of claim 1 to detect people and/or to detect motions in a scene.
